(19) United States
(12) Patent Application Publication
(10) Pub. No.: US 2026/0043992 A1
(43) Pub. Date: Feb. 12, 2026

(54) Technologies for Simultaneous Sampling of More Than One Sample Plane Using a Mirrored Pinhole Array

(71) Applicant: Colgate-Palmolive Company, New York, NY (US)

(72) Inventors: Benny E. URBAN, JR., Somerset, NJ (US); Hrebesh Molly SUBHASH, Somerset, NJ (US)

(73) Assignee: Colgate-Palmolive Company, New York, NY (US)

(21) Appl. No.: 18/865,761

(22) PCT Filed: May 15, 2023
(86) PCT No.: PCT/US2023/022271

§ 371 Date: Nov. 14, 2024

Related U.S. Application Data
(60) Provisional application No. 63/342,213, filed on May 16, 2022.

(51) Int. Cl. G02B 21/00; G02B 17/08; G02B 27/58

(52) U.S. Cl. CPC G02B 21/006; G02B 17/08; G02B 21/0072; G02B 27/58

(57) ABSTRACT

Technologies are disclosed for simultaneous measurement of one or more properties of a sample at one or more sample depths that may be performed by an imaging device. The imaging device may comprise a mirror. The device may comprise a mirrored pinhole array that may comprise one or more pinholes. A mirrored pinhole array cavity may be formed by an arrangement of the mirror and the mirrored pinhole array. The mirrored pinhole array may be configured to focus light from one or more sample planes within the mirrored pinhole array cavity. The device may comprise at least one lens that may be arranged with the mirrored pinhole array to collect the focused light from the one or more sample planes via at least one pinhole of the one or more pinholes. The device may comprise a detector arranged with the at least one lens to receive the collected light.

### CROSS-REFERENCE TO RELATED APPLICATION

This application claims the benefit of priority from U.S. Provisional Application No. 63/342,213, filed May 16, 2022, the contents of which are hereby incorporated herein by reference in their entirety.

### BACKGROUND

Confocal microscopy includes capturing a plurality of two-dimensional images at different sample depths. Such images may enable optical sectioning, which is the reconstruction of three-dimensional parts/elements from within the sample object. This technique can be applied to various objects, such as semiconductors, human and/or animal tissue, and/or metal samples, among other objects/materials.

In confocal microscopy, excitation light (e.g., laser light) may be focused at one depth level of a sample/object at a time. Since only one point in the sample/object is imaged at a time, confocal based imaging requires scanning over some pattern and/or some number of scanning lines/sections in the sample. Adjustable mirrors (e.g., motorized and/or automatically controlled) that adjust the path of light may be used to facilitate the scanning of the sample/object over the pattern of the sample to obtain measurements from other depths of the sample over some period of scanning time. The longer and/or more often that a sample pattern/section may be scanned to obtain measurements at various depths of the sample, the more excitation light radiation that may be conveyed to the sample.

### SUMMARY

Technologies are disclosed for simultaneous measurement of one or more properties of a sample at one or more sample depths that may be performed by an imaging device. The device may comprise a mirror. The device may comprise a mirrored pinhole array that may comprise one or more pinholes (e.g., one pinhole, at least two pinholes, a plurality of pinholes, and/or multiple pinholes, etc.). A mirrored pinhole array cavity may be formed by an arrangement of the mirror and the mirrored pinhole array.

The mirrored pinhole array may be configured to focus at least some light from one or more sample planes within the mirrored pinhole array cavity. The device may comprise at least one lens. The at least one lens may be arranged with the mirrored pinhole array to collect at least some of the focused light from the one or more sample planes via at least one pinhole of the one or more pinholes (e.g., one pinhole, at least two pinholes, a plurality of pinholes, and/or multiple pinholes, etc.). The device may comprise a detector. The detector may be arranged with the at least one lens to receive at least some of the collected light.

Technologies are disclosed for one or more methods/techniques of simultaneously measuring of one or more properties of a sample at one or more sample depths with an imaging device. The imaging device may comprise a mirror, a mirrored pinhole array comprising one or more pinholes (e.g., one pinhole, at least two pinholes, a plurality of pinholes, and/or multiple pinholes, etc.), at least one lens, and/or a detector. One or more techniques may comprise arranging the mirror and the mirrored pinhole array to form a mirrored pinhole array cavity. One or more techniques may comprise focusing at least some light from one or more sample planes within the mirrored pinhole array.

One or more techniques may comprise arranging the mirrored pinhole array to collect at least some of the focused light from the one or more sample planes via at least one pinhole of the one or more pinholes (e.g., one pinhole, at least two pinholes, a plurality of pinholes, and/or multiple pinholes, etc.). One or more techniques may comprise receiving, at the detector via the at least one lens, at least some of the collected light.

Technologies are disclosed for one or more techniques for simultaneous sampling of different planes in a volumetric sample for real-time volumetric optical measurements of one or more sample properties. One or more techniques may comprise a mirrored pinhole-array cavity for axial sampling, one or more other optical components, and at least one detector. The mirrored pinhole-array cavity may be used for passive confocal-type sectioning of one or more different planes and/or may be combined with one or more different optical imaging and/or spectroscopy techniques/technologies, perhaps for example to increase axial sampling throughput.

One or more techniques described herein may increase sampling throughput and/or imaging rate(s) with one or more (e.g., multiple) pinholes utilized in the cavity array. The applications of the technologies disclosed herein may include/range from faster microscopy imaging to consumer-level hand-held compact devices that may be capable of snap-shot volumetric property measurements, for example.

### BRIEF DESCRIPTION OF DRAWINGS

The elements and other features, advantages and disclosures contained herein, and the manner of attaining them, will become apparent and the present disclosure will be better understood by reference to the following description of various examples of the present disclosure taken in conjunction with the accompanying drawings, wherein:

FIG. 1 illustrates an example diagram of a device comprising a mirrored pinhole-array cavity.

FIG. 2A and FIG. 2B illustrate an example of a measurement performed by a mirrored pinhole-array cavity of multiple samples/depths sectioning.

FIG. 3 is an example flow diagram of at least one technique for simultaneously measuring one or more properties of a sample at one or more sample depths.

FIG. 4 is a block diagram of a hardware configuration of an example device that may serve as at least a part of a detector of a mirrored pinhole array cavity device.

FIG. 5A and FIG. 5B are an example diagrams of fabricated pinhole arrays on different mirror shapes.

FIG. 6 illustrates an example mirrored pinhole array cavity device with one or more spectroscopic elements.

FIG. 7A, FIG. 7B, and FIG. 7C illustrate experimental data acquired from an example confocal mirrored pinhole array device.

FIG. 8A and FIG. 8B illustrate an example setup for widefield and/or super-resolution imaging using a mirrored pinhole array cavity device.

FIG. 9A and FIG. 9B illustrate an example of a consumer level Raman scattering diagnostic device/technique using a mirrored pinhole array cavity.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of this disclosure is thereby intended.

The subject matter described herein relates to optical measurement and/or imaging techniques. For example, one or more devices and/or techniques described herein may provide improvements in optical technology that may allow for simultaneous measurement of one or more sample properties at one or more different depths (e.g., different planes).

In one or more optical measurement techniques, gaining axial information about samples may be problematic and/or may require axial movement of optics and/or (e.g., relatively) complex setups such as with light-field, among other scenarios. For example, in cases of lateral imaging/spectroscopy (e.g., 2D information gained from a photograph), photons may carry information to a detector, perhaps through one or more optical components, and/or may form the (e.g., commonly used) X-Y 2D image on a screen/display device. The in-focus information may be within the detector optics “depth-of-field” and/or can be (e.g., perhaps easily) imaged and/or used for spectroscopy.

The photons from outside the depth-of-field might not be properly/adequately focused onto the detector and/or may result in blur and/or background noise. These background photons may carry the spectroscopic and/or structural information of the object from which they were scattered. In one or more scenarios, these photons might not be correctly focused on the detector, perhaps for example due to the nature of the focusing lenses and/or mirrors, among other reasons. In such scenarios, among others, light beyond the depth-of-field may be (e.g., normally) undesirable, detrimental, and/or un-useful.

In one or more scenarios, the removal of photons outside the depth-of-field may include adding a pinhole in the imaging plane (e.g., the imaging plane where a detector may, perhaps normally, be located). The pinhole may reject light emanating from outside the focal plane of the optics. In such scenarios, light coming from the axial plane of interest may be (e.g., only may be) allowed to make it/pass to/be communicated to a detector that may be placed on the other side of the pinhole. Such techniques may make it possible for imaging of specific depths in a sample, perhaps for example by axially and/or laterally scanning the sample with a light source, such as a laser (among other light sources). Such techniques might (e.g., often) require (e.g., relatively) long exposure of high energy photons to delicate or living samples. This can have negative consequences for the sample, such as heating, photobleaching, and/or photo-toxicity, for example.

In confocal imaging, photons scattering and/or irradiating from other planes in the sample may (e.g., may still) contain the information about the sample structure and/or spectra. Such photons, if harnessed, could also be used to measure one or more sample properties from one or more other sample planes. Current/existing confocal imaging configurations might not allow for the (e.g., simultaneous) sampling of many planes as described herein, which may cause relatively long exposure to radiation and/or can affect one or more sample properties and/or may induce one or more motion artifacts.

Technologies providing for simultaneous and/or high-resolution axial depth information of one or more many planes simultaneously may be useful and/or may satisfy one or more unmet needs in the art. Such technologies can be used in microscopy, spectroscopy, clinically for diagnostics, and/or in compact form factors, perhaps for consumer level devices, for example. Such technologies could be applied for use in solid state, soft materials diagnostics, and/or disease detection. For example, by simultaneously gaining information from one or more (e.g., numerous) planes, the burden of axial sampling through (e.g.,) largely mechanical effort/apparatus/components can be overcome and/or could reduce exposure of samples to (e.g., often) intense and/or high energy radiation.

Solutions to one or more problems in the field of optical diagnostics such as, for example, slow sampling leading to motion artifacts, long exposure of light leading to sample photobleaching and/or phototoxicity, and/or exposing numerous planes to excitation light which also may cause photobleaching and/or phototoxicity may be useful. For example, technologies that may replace, at least in part, one or more mechanical moving component(s) with a passive stationary component which may reduce system vibrations, heat, and/or complexity may be useful.

One or more current/existing optical techniques such as Optical Coherence Microscopy (OCM) and/or Optical Resolution Photoacoustic Microscopy (OR-PAM) may be used for simultaneous axial sampling into tissues. Techniques, such as OCT may give structural, polarization, and/or spectral information about one or more sample properties. At least one physical limitation of OCT is its lack of ability to image fluorescence, for example, in contrast with a capability of (e.g., strength of) confocal imaging. Other techniques, such as light-field microscopy, can measure axial information in a single shot, but cannot measure inside volumetric samples to (e.g., high) depths, perhaps for example without stochastic “blinking” to help localize the region of fluorescence, among other issues. Confocal imaging may allow for imaging of fluorescence and/or back scattered light, perhaps with the trade-off of (e.g., relatively) long imaging times for lateral and/or axial scanning.

One or more techniques and/or devices described herein for confocal scanning can increase the number of axially sectioned planes and/or may reduce sampling to a (e.g., single) detector may use a mirrored pinhole-array cavity in combination with an array detector, for example. A mirrored pinhole-array cavity may include at least one mirror and another (e.g., a second) mirror with one or more arrays of transmissive pinholes. Light emanating from one or more different planes may be (e.g., weakly) focused into the cavity. The focused light may (e.g., eventually) enter at least one of the pinholes in the array that may correspond to a specific imaging plane. Light passing through one or more, or each, pinhole can be focused onto an array detector for simultaneous axial sampling of one or more, or many, planes of the sample. One or more such techniques and/or devices may pass the burden of axial sectioning to a single cavity element and/or detector, for example, among other arrangements.

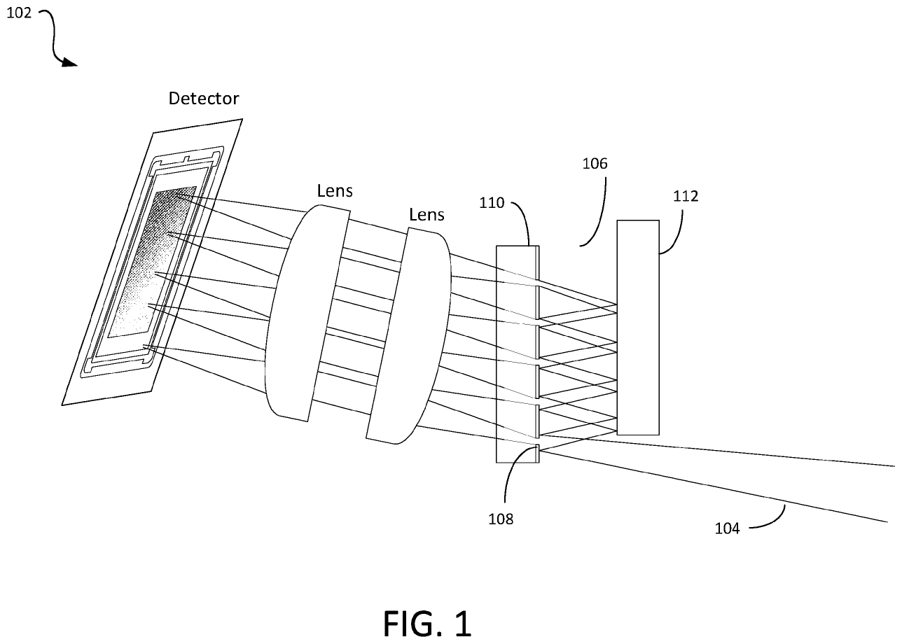

FIG. 1 illustrates an example diagram of a device 102 comprising a mirrored pinhole-array cavity. The figure shows light from one or more different planes 104 being (e.g., weakly) focused into a mirrored array cavity 106. The weakly focused light may pass through at least one of the pinholes 108 (e.g., as an example of multiple pinholes) in a mirror/mirrored pinhole array 110 as arranged with a mirror 112, perhaps for example based on the sample plane the light originated from and/or a magnification of the system/device. For example, the mirrored pinhole-array cavity 106 can be used with a microscope (not shown), for example, where light collected by one or more objective lenses (e.g., that may be at least one of the illustrated lenses in FIG. 1 and/or another lens(es) not shown) may be magnified.

In one or more scenarios, the magnification may relate to the spacing of each plane (not shown) between the sampling and the imaging plane by the equation: ΔZ=M² Δz, where ΔZ is the spacing between the pinholes (not shown). M is a system magnification (e.g., before the pinholes, not shown), and Δz is the plane spacing in the sampling plane (not shown). The light may be weakly focused into the pinhole array cavity 106 as shown in FIG. 1 and/or may be separated by the imaging plane it originated from. Among other kinds of sampling, the device 102 may be used for passive axial sampling, for example.

In one or more scenarios, a (e.g., relatively) low Numerical Aperture (NA) for excitation can be used to illuminate one or more, or many planes (not shown). A high NA for sampling can be used for achieving (e.g., relatively) high resolution in the axial and/or lateral planes (not shown). Light that may be collected by the one or more lenses (e.g., the illustrated lenses and/or lenses not shown) can be magnified, perhaps for example to get larger spacing between the different imaging planes. The light may be weakly focused into the mirrored pinhole-array cavity 106 and/or may be axially sampled, for example. The light can be collected by one or more lenses (e.g., the illustrated lenses and/or lenses not shown) and/or a relay before being incident and/or focused on the detector.

In one or more scenarios, the mirrored pinhole array cavity may be created using mirrors that may face each other. The angle of a first mirror that may contain the pinhole array, may be off set a few degrees from normal with respect to the incidence beam, perhaps for example to reflect light towards a second mirror in the cavity. In the example of FIG. 1, the first mirror 110 contains the pinholes 108, but the mirror positions can also be changed. In one or more scenarios, the pinholes' 108 diameters (not shown) may be preselected diameters.

In one or more scenarios, the angle may range from some degree from >0 degrees and <90 degrees from the normal of the mirror surface. Angles very close to or approaching 0 degrees might not be useful as such angles might send the light back on the same path that the light entered. Angles very close to or approaching 90 degrees might not be useful as such angles might send the light straight through the cavity without hitting the mirror, for example. In one or more scenarios, a spacing of the pinholes 108 and/or a shape of the pinholes 108 may be considered in angle selection.

In one or more scenarios the pinholes 108 may be deployed with linear or nonlinear spacing (not shown). The spacing between the mirrors 110 and 112 can be adjusted, perhaps for example based on the magnification of the system and/or a desired distance between the one or more sampling planes as described herein. One or more volumetric images can be formed using one or more (e.g., a single) X-Y scan, perhaps for example instead of one or more X-Y-Z scans.

Pinhole diameter can be selected based on the desired axial and/or lateral resolution for the system. In one or more scenarios, the pinhole diameter can be determined by the illumination wavelength and/or detected radiation. For example, the standard range of 0.25 to 3 Airy Unit (AU) can be selected to balance the signal-to-noise ratio and/or for achieving high resolutions, which may be dependent of the system setup (e.g., Numerical Aperture of objective, refractive index of immersion media, and/or efficiency of optics), illumination wavelength, detecting wavelengths, and/or number of photons being collected. In one or more scenarios, the shape of the pinhole can be an oval, perhaps for example so that the cross-section may be a near circle based on light being incident at an angle, among other scenarios.

The axial resolution may be given by the common confocal equation

$${FWHM}_{res \_ axial} = \sqrt{{( \frac{0.88 * {λ}_{e m}}{n - \sqrt{{n}^{2} + {NA}^{2}}} )}^{2} + {( \frac{\sqrt{2} * n * PH}{NA} )}^{2}} ,$$

where FWHM is the full-width at half-max of the measured point spread function (PSF), λₑₘ is the emission wavelength, n is the refractive index of the media, NA is the collection numerical aperture, and PH is the pinhole diameter. Larger pinholes may give higher signal, perhaps with some tradeoff in a reduction of the confocal improvement in resolution. The sample plane may have a varying NA, perhaps for example depending on where the light is collected. Perhaps for example to maintain constant SNR and/or axial sampling resolution, a nonlinear distribution of pinhole size and/or spacing can be utilized to maintain similar axial and/or lateral resolutions (e.g., as provide by the equations herein). For example, light collected closer to the objective lens may have a higher NA compared to light collected farther away from the objective lens. Perhaps for example because that axial resolution is inversely proportional to the square of the NA, among other reasons, a nonlinear distribution of pinhole sizes and/or distance between pinholes can be used to maintain consistent resolution.

In one or more scenarios, a particular sample plane may be selected by a geometric calculation of the entrance angle of the radiation into the pinhole mirror cavity. This may place the first image focal plane (e.g., the imaging plane related to the sample plane closest to the objective lens) in the location of the first pinhole. The spacing of the reflection mirror (e.g., the mirror without the pinhole array, such as mirror 112) may be adjusted in such a way that the distance light may (e.g., must) travel between the first reflection from the pinhole array mirror (e.g., mirror 110) to the reflection mirror and then back to the pinhole array mirror may be equal to some distance D. In one or more scenarios, D may be related to the distance between sample planes, z, by the equation ΔD≈M² Δz, where M is the magnification of the system. In one or more scenarios ΔD may be related to, may equal, and/or may correspond to, ΔZ as described herein.

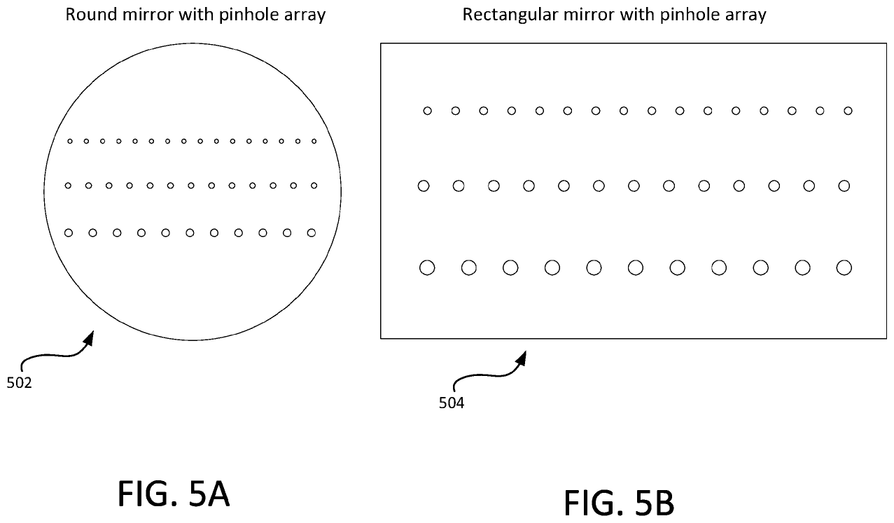

In one or more scenarios, the mirror containing the pinholes can contain one or more, or multiple, arrays of pinholes at one or more different locations on the mirror. The pinhole array on the mirror can then be selected to match the sampling requirements of the user, as shown for example in FIG. 5A and FIG. 5B. In FIG. 5A and FIG. 5B, example fabricated pinhole arrays 502 and 504 on different mirror shapes are illustrated. Array shapes other than those illustrated in FIGS. 5A and 5B are contemplated. The circles are the pinholes may be of different sizes and/or spacing. In one or more scenarios, for example, it may be useful to make a nonlinear pinhole array for sampling one or more different planes at known locations and/or changing the sampling thickness of one or more, or each plane.

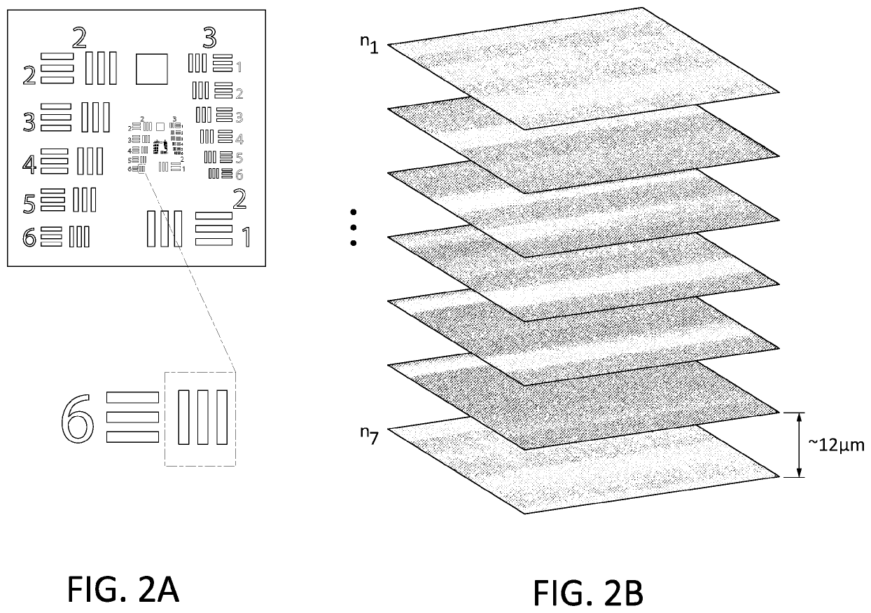

FIG. 2A and FIG. 2B illustrate an example of a measurement performed by a mirrored pinhole-array cavity of multiple samples/depths sectioning, where multiple samples were imaged. As illustrated in FIG. 2A, a USAF resolution target was sampled at multiple depths to determine lateral and axial resolution. FIG. 2B illustrates seven planes of the target imaged via at least seven pinholes of a mirrored pinhole array. Lateral resolution may be dependent on the illumination NA and, in one or more testing scenarios, was determined to be 0.73 μm with an illumination wavelength of 650 nm. Axial resolution may be dependent on the collection NA and/or the size of the pinhole diameter and/or the collected radiation wavelengths according to equation

$${FWHM}_{res \_ axial} = \sqrt{{( \frac{0.88 * {λ}_{e m}}{n - \sqrt{{n}^{2} + {NA}^{2}}} )}^{2} + {( \frac{\sqrt{2} * n * PH}{NA} )}^{2}}$$

(e.g., as described herein).

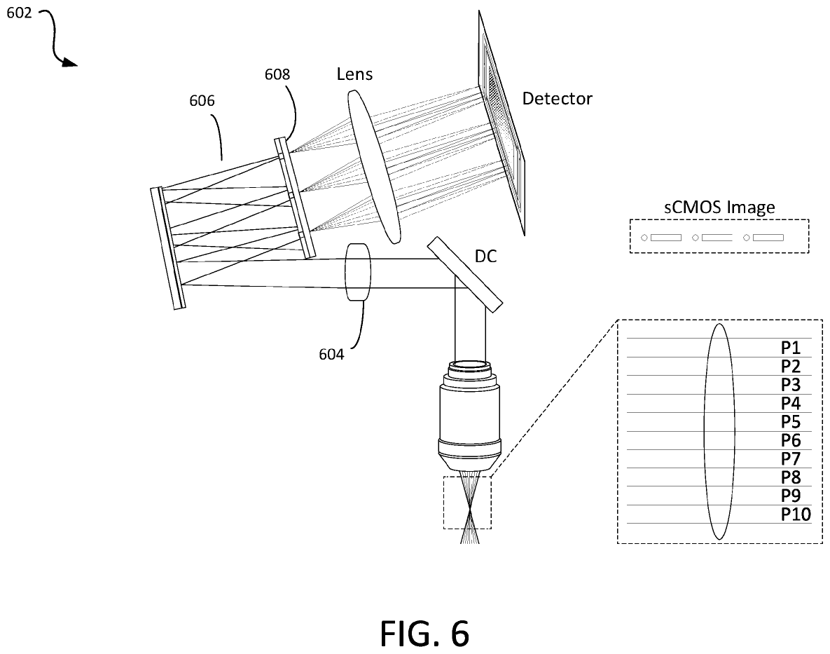

In one more scenarios, a mirrored pinhole array cavity device can have one or more spectroscopy elements that may add the ability/capability to acquire spectroscopic data as shown in FIG. 6. In one or more scenarios, a mirrored pinhole array cavity device system can utilize one or more, or multiple, excitation beams (e.g., simultaneously) for excitation of one or more, or numerous, fluorophores and/or in reflectance configurations (e.g., spectroscopic, reflectance, and/or confocal).

FIG. 6 illustrates an example mirrored pinhole array cavity device 602 with one or more spectroscopic elements. A tube lens (TL) 604 may be used to focus the light into the mirrored pinhole array cavity 606. Perhaps for example on the transmission side of the mirrored pinhole array cavity 606, a transmission grating (TG) 608 may be utilized to separate the spectra. The spectra may be imaged along with the 0^{th} order transmission perhaps for example to determine the amount of light absorbed, reflected, and/or fluoresced from one or more different planes.

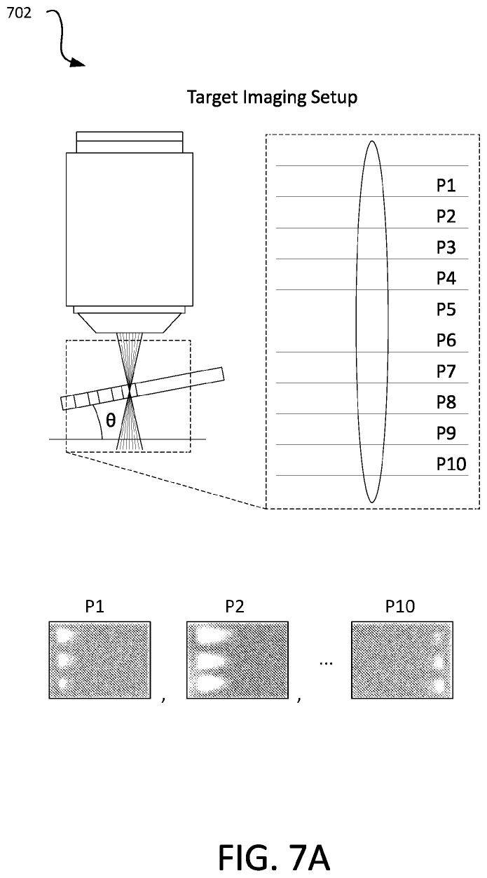

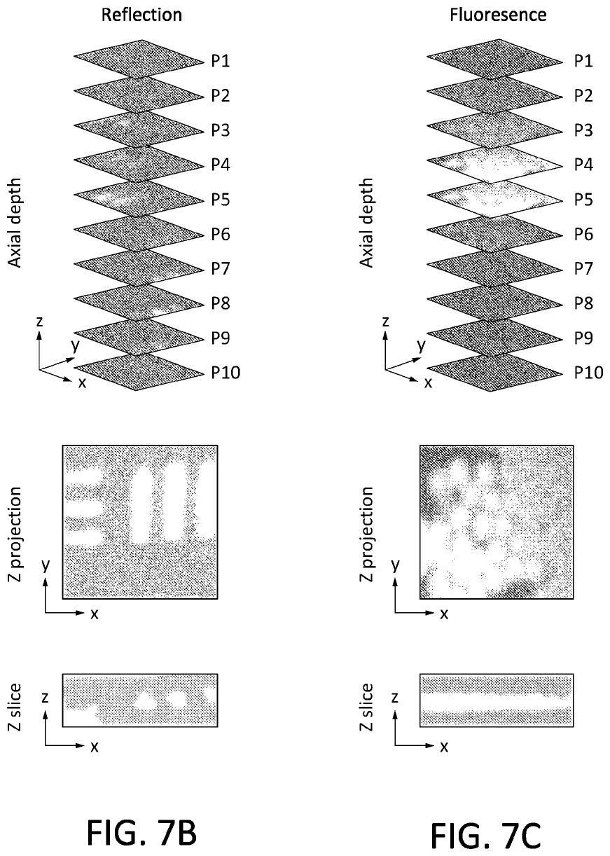

FIG. 7A, FIG. 7B, and FIG. 7C illustrate experimental data acquired from an example confocal mirrored pinhole array cavity device, such as a microscope, for example. FIG. 7A illustrates the example device/system setup/configuration 702 for an experimental demonstration of passive axial scanning of a reflective 1951 USAF resolution target (e.g., group 3, element 6). The target was placed at a (e.g., relatively) small angle, θ, to demonstrate sample level sectioning capabilities of the device. P1, P2, and P10 are images created from pinhole 1, 2, and 10 during a (e.g., single) lateral scan, for example.

FIG. 7B illustrates experimental results of scanning the 1951 USAF target at a different angle. The top of FIG. 7B shows each individual reconstructed plane from the ten (10) different pinholes. The middle of FIG. 7B shows the z-projection of the images P1 through P10. The bottom of FIG. 7B shows the X-Z view of the generated volume. FIG. 7C illustrates a 6 μm diameter fluorescent sphere samples imaged using a fluorescence mode of the confocal mirrored pinhole array cavity microscope. The principles are the same as used to produce the experimental results of FIG. 7B, but fluorescence is imaged instead of reflection. The top of FIG. 7C illustrates generally the same results as the top of FIG. 7B, but for the fluorescent spheres imaged in FIG. 7C. The middle of FIG. 7C illustrates generally the same as the middle of FIG. 7B, but for the fluorescent spheres imaged in FIG. 7C. The bottom of FIG. 7C illustrates generally the same as the bottom of FIG. 7B, but for the fluorescent spheres imaged in FIG. 7C.

Data collected from the confocal pinhole array can be utilized for axial sampling in reflectance confocal. Raman, fluorescence, and/or any other optical radiation method. This may allow for a diverse application of the axial sampling technique with the mirrored pinhole array cavity. In the cases of spectroscopic sampling, for example, data can be used for opto-electric characterization of solid state and/or soft materials. In the case of soft materials, for example, characterization can be used for diagnostics. For example, spectroscopic reflectance microscopy with the passive axial sampling can give (e.g., real-time) imaging of blood and/or tissue functional information. In one or more scenarios, one or more mirrored pinhole array cavity device techniques may include determining the oxygen level of individual cells in the body, for example.

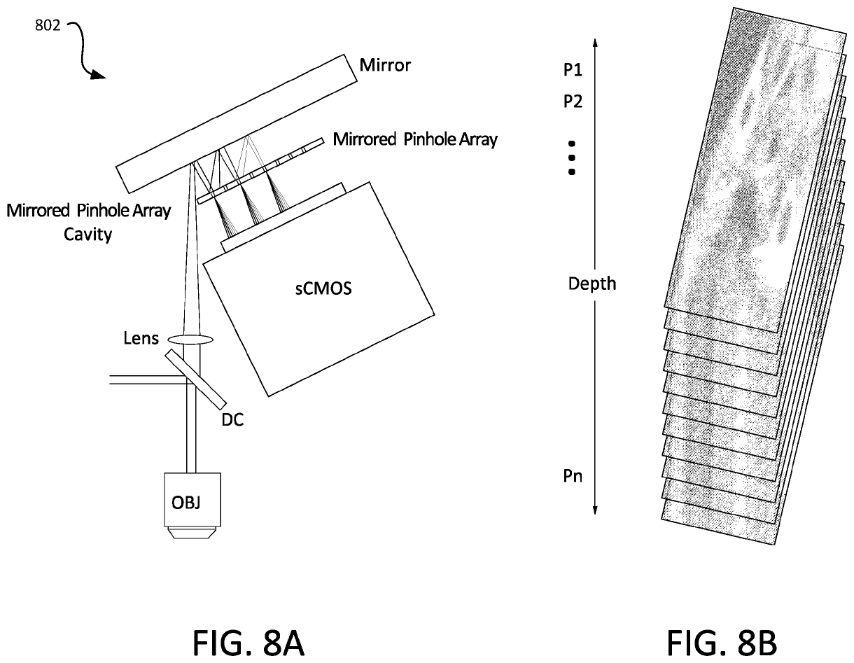

Confocal microscopy is one of many applications for the confocal mirrored pinhole array cavity devices and techniques. At least another application may be to segment one or more, or multiple, imaging planes in widefield imaging. At least another application may be to use the system in photon localization super-resolution microscopy. In widefield-type applications, the optics to the detector may be changed to project the image, perhaps for example instead of focusing the point source. For example, in photon localization, the optics could be the same as widefield, but perhaps the stochastic properties of the fluorophores could allow for stochastic optical reconstruction of one or more, or numerous, planes for super-resolution tissue imaging, examples of which are illustrated in FIG. 8A and FIG. 8B.

FIG. 8A and FIG. 8B illustrate an example setup for widefield and/or super-resolution imaging using a mirrored pinhole array cavity device 802. Perhaps unlike confocal microscopy, the light might not be scanned and/or may be rather focused to project an image onto the detector. In the case of stochastic light, for example, the light intensity changes from the one or more different planes can be harnessed for super-resolution photon localization in different tissue planes.

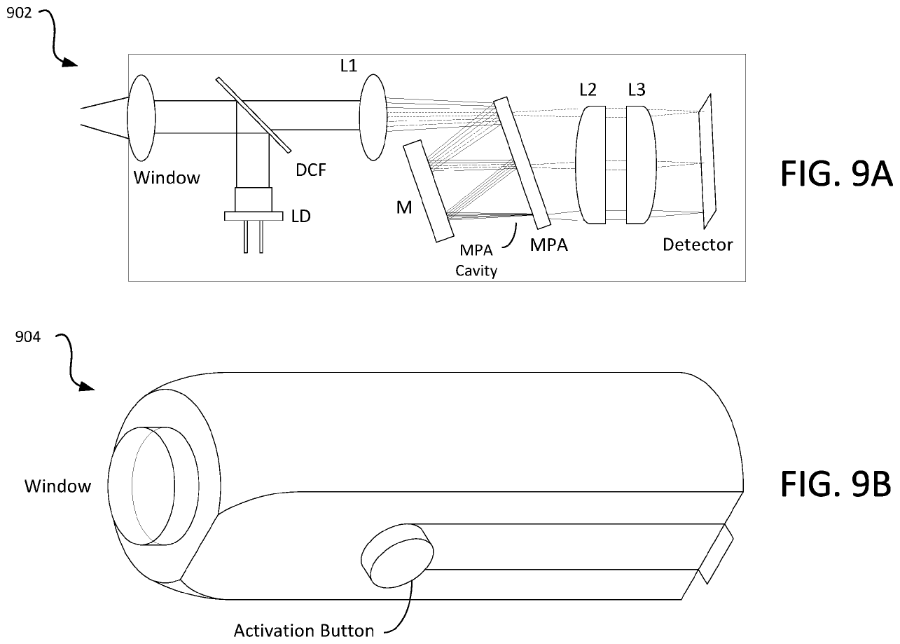

In one or more scenarios, passive axial sampling techniques and devices can be used for consumer level diagnostic devices. Perhaps instead of convolved imaging planes and/or a single imaging plane, more than one, or multiple, imaging planes can be harnessed to detect tissue conditions. An example idea that uses Raman scattering from one or more different planes is illustrated in FIG. 9A and FIG. 9B. In at least one consumer level device 902, a laser diode LD with a (e.g., relatively) large diameter beam may be used to illuminate tissue, perhaps for example in a contact mode. Light may be collected through a lens L1. The laser light may be removed using filter DCF. Raman scattered light may be focused into the confocal MPA cavity that may be formed between mirror M and mirrored pinhole array MPA. The mirror pinhole array MPA may section one or more, or each plane. Perhaps because the light may come from a (e.g., relatively) large area of the tissue (not shown), among other reasons, one or more bulk properties can be measured at one or more different tissue layers, for example.

In FIG. 9A, perhaps after passing through the respective pinholes of the MPA that may correspond to specific depths in the tissue, the light may be separated using a transmission grating (not shown) and/or lens L2 and/or lens L3, perhaps for example before being detected using an array detector. One or more, or each plane Raman spectra can be analyzed, perhaps for example to determine biomolecules in the tissue layer (e.g., collagen, melanin, and/or clastic, etc.). The biomolecule presence can then be analyzed, perhaps for example to determine tissue health and/or possibly recommend products and/or medical visits.

Stated somewhat differently, FIG. 9A illustrates one or more internal optical components of the consumer level Raman scattering diagnostic device 902 using the MPA cavity. Light from the laser diode LD may pass through the window. Back scattered light may pass through a dichroic filter DCF to remove laser light and/or allow Raman scattering to pass, for example. Light may be focused using lens L1 into the MPA cavity. The MPA cavity may be formed by the mirrored pinhole array MPA and the mirror M. Light that passes through the pinholes may be relayed using lenses L2 and/or L3 to the detector. FIG. 9B illustrates an example housing 904 of the device 902 with an operator/consumer activation button that may be used to acquire the data.

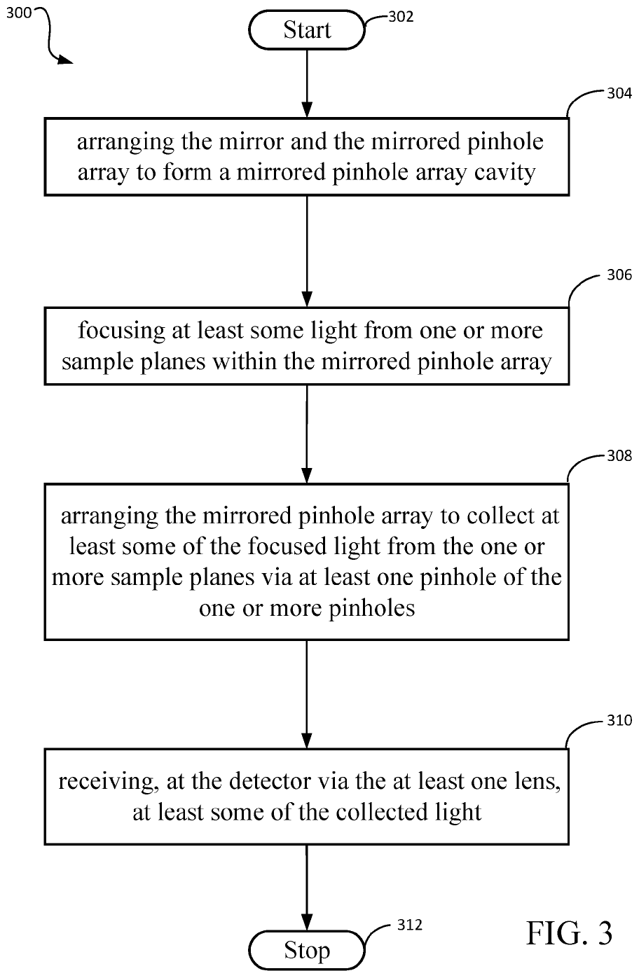

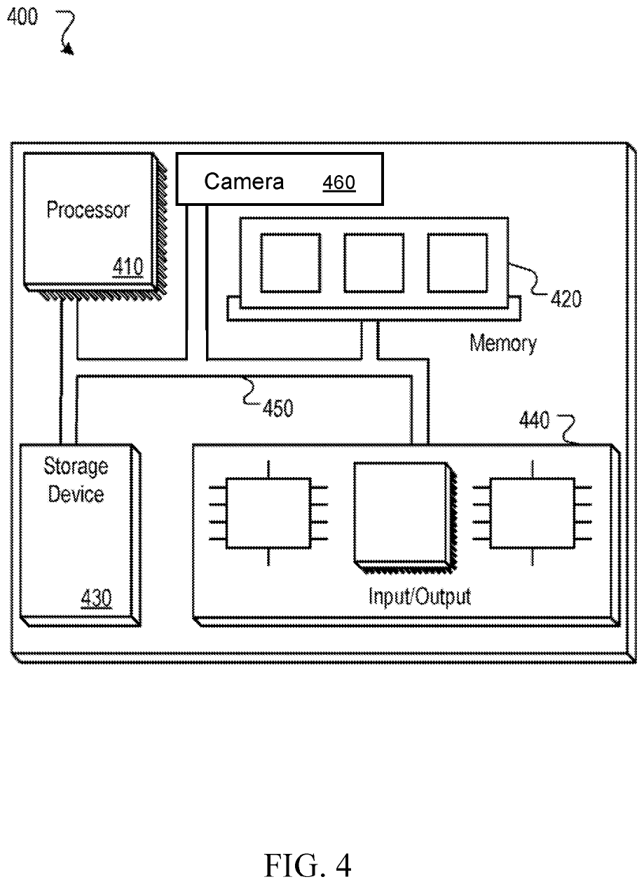

In FIG. 3, diagram 300 illustrates an example technique for simultaneously measuring one or more properties of a sample at one or more sample depths. The method may be performed by an imaging device, among other devices. The imaging device may comprise a mirror, a mirrored pinhole array that may comprise one or more pinholes (e.g., one pinhole, at least two pinholes, a plurality of pinholes, and/or multiple pinholes, etc.), at least one lens, and/or a detector. At 302, the process may start or restart.

At 304, the imaging device may arrange the mirror and the mirrored pinhole array to form a mirrored pinhole array cavity. At 306, the imaging device may focus at least some light from one or more sample planes within the mirrored pinhole array.

At 308 the imaging device may arrange the mirrored pinhole array to collect at least some of the focused light from the one or more sample planes via at least one pinhole of the one or more pinholes. At 310, the imaging device may receive, at the detector via the at least one lens, at least some of the collected light. At 312 the process may stop or restart.

FIG. 4 is a block diagram of a hardware configuration of an example device that may function as a control device/logic controller that may serve as, comprise, control, and/or be in communication with any of the detectors and/or any of the imaging devices described herein, for example. The hardware configuration 400 may be operable to facilitate delivery of information from an internal server of a device. The hardware configuration 400 can include a processor 410, a memory 420, a storage device 430, and/or an input/output device 440. One or more of the components 410, 420, 430, and 440 can, for example, be interconnected using a system bus 450. The processor 410 can process instructions for execution within the hardware configuration 400. The processor 410 can be a single-threaded processor or the processor 410 can be a multi-threaded processor. The processor 410 can be capable of processing instructions stored in the memory 420 and/or on the storage device 430.

The memory 420 can store information within the hardware configuration 400. The memory 420 can be a computer-readable medium (CRM), for example, a non-transitory CRM. The memory 420 can be a volatile memory unit, and/or can be a non-volatile memory unit.

The storage device 430 can be capable of providing mass storage for the hardware configuration 400. The storage device 430 can be a computer-readable medium (CRM), for example, a non-transitory CRM. The storage device 430 can, for example, include a hard disk device, an optical disk device, flash memory and/or some other large capacity storage device. The storage device 430 can be a device external to the hardware configuration 400.

The input/output device 440 may provide input/output operations for the hardware configuration 400. The input/output device 440 (e.g., a transceiver device) can include one or more of a network interface device (e.g., an Ethernet card), a serial communication device (e.g., an RS-232 port), one or more universal serial bus (USB) interfaces (e.g., a USB 2.0 port) and/or a wireless interface device (e.g., an 802.11 card). The input/output device can include driver devices configured to send communications to, and/or receive communications from one or more networks (e.g., Manufacturing Control Network 130 of FIG. 1). The input/output device 400 may be in communication with one or more input/output modules (not shown) that may be proximate to the hardware configuration 400 and/or may be remote from the hardware configuration 400. The one or more output modules may provide input/output functionality in the digital signal form, discrete signal form. TTL form, analog signal form, serial communication protocol, fieldbus protocol communication and/or other open or proprietary communication protocol, and/or the like.

The camera device 460 may provide digital video input/output capability for the hardware configuration 400. The camera device 460 may communicate with any of the elements of the hardware configuration 400, perhaps for example via system bus 450. The camera device 460 may capture digital images and/or may scan images of various kinds, such as Universal Product Code (UPC) codes and/or Quick Response (QR) codes, for example, among other images as described herein. In one or more scenarios, the camera device 460 may be the same and/or substantially similar to any of the other camera devices described herein.

The camera device 460 may include at least one microphone device and/or at least one speaker device. The input/output of the camera device 460 may include audio signals/packets/components, perhaps for example separate/separable from, or in some (e.g., separable) combination with, the video signals/packets/components the camera device 460.

The camera device 460 may be in wired and/or wireless communication with the hardware configuration 400. In one or more scenarios, the camera device 460 may be external to the hardware configuration 400. In one or more scenarios, the camera device 460 may be internal to the hardware configuration 400.

The subject matter of this disclosure, and components thereof, can be realized by instructions that upon execution cause one or more processing devices to carry out the processes and/or functions described herein. Such instructions can, for example, comprise interpreted instructions, such as script instructions, e.g., JavaScript or ECMAScript instructions, or executable code, and/or other instructions stored in a computer readable medium.

Implementations of the subject matter and/or the functional operations described in this specification and/or the accompanying figures can be provided in digital electronic circuitry, in computer software, firmware, and/or hardware, including the structures disclosed in this specification and their structural equivalents, and/or in combinations of one or more of them. The subject matter described in this specification can be implemented as one or more computer program products, e.g., one or more modules of computer program instructions encoded on a tangible program carrier for execution by, and/or to control the operation of, data processing apparatus.

A computer program (also known as a program, software, software application, script, or code) can be written in any form of programming language, including compiled or interpreted languages, and/or declarative or procedural languages. It can be deployed in any form, including as a stand-alone program or as a module, component, subroutine, and/or other unit suitable for use in a computing environment. A computer program may or might not correspond to a file in a file system. A program can be stored in a portion of a file that holds other programs and/or data (e.g., one or more scripts stored in a markup language document), in a single file dedicated to the program in question, and/or in multiple coordinated files (e.g., files that store one or more modules, sub programs, or portions of code). A computer program can be deployed to be executed on one computer or on multiple computers that may be located at one site or distributed across multiple sites and/or interconnected by a communication network.

The processes and/or logic flows described in this specification and/or in the accompanying figures may be performed by one or more programmable processors executing one or more computer programs to perform functions by operating on input data and/or generating output, thereby tying the process to a particular machine (e.g., a machine programmed to perform the processes described herein). The processes and/or logic flows can also be performed by, and apparatus can also be implemented as, special purpose logic circuitry, e.g., an FPGA (field programmable gate array) and/or an ASIC (application specific integrated circuit).

Computer readable media suitable for storing computer program instructions and/or data may include all forms of non-volatile memory, media and memory devices, including by way of example semiconductor memory devices (e.g., EPROM, EEPROM, and/or flash memory devices); magnetic disks (e.g., internal hard disks or removable disks); magneto optical disks; and/or CD ROM and DVD ROM disks. The processor and/or the memory can be supplemented by, or incorporated in, special purpose logic circuitry.

While this specification and the accompanying figures contain many specific implementation details, these should not be construed as limitations on the scope of any invention and/or of what may be claimed, but rather as descriptions of features that may be specific to described example implementations. Certain features that are described in this specification in the context of separate implementations can also be implemented in combination in perhaps one implementation. Various features that are described in the context of perhaps one implementation can also be implemented in multiple combinations separately or in any suitable sub-combination. Although features may be described above as acting in certain combinations and/or perhaps even (e.g., initially) claimed as such, one or more features from a claimed combination can in some cases be excised from the combination. The claimed combination may be directed to a sub-combination and/or variation of a sub-combination.

While operations may be depicted in the drawings in an order, this should not be understood as requiring that such operations be performed in the particular order shown and/or in sequential order, and/or that all illustrated operations be performed, to achieve useful outcomes. The described program components and/or systems can generally be integrated together in a single software product and/or packaged into multiple software products.

Examples of the subject matter described in this specification have been described. The actions recited in the claims can be performed in a different order and still achieve useful outcomes, unless expressly noted otherwise. For example, the processes depicted in the accompanying figures do not require the particular order shown, and/or sequential order, to achieve useful outcomes. Multitasking and parallel processing may be advantageous in one or more scenarios.

While the present disclosure has been illustrated and described in detail in the drawings and foregoing description, the same is to be considered as illustrative and not restrictive in character, it being understood that only certain examples have been shown and described, and that all changes and modifications that come within the spirit of the present disclosure are desired to be protected.

1. An imaging device configured for simultaneous measurement of one or more properties of a sample at one or more sample depths, the device comprising:
a mirror;
a mirrored pinhole array comprising one or more pinholes;
a mirrored pinhole array cavity formed by an arrangement of the mirror and the mirrored pinhole array, the mirrored pinhole array configured to focus at least some light from one or more sample planes within the mirrored pinhole array cavity;
at least one lens, the at least one lens arranged with the mirrored pinhole array to collect at least some of the focused light from the one or more sample planes via at least one pinhole of the one or more pinholes; and
a detector, the detector arranged with the at least one lens to receive at least some of the collected light.

2. The device of claim 1, wherein the mirrored pinhole array is further configured to focus a substantial portion of the light from the one or more sample planes.

3. The device of claim 1, wherein the mirrored pinhole array is further configured such that the at least one pinhole of the one or more pinholes via which the at least some of the focused light from the one or more sample planes is communicated to the at least one lens is based on at least one of: a sample plane from which the light originated, or a magnification of the device.

4. The device of claim 1, wherein the arrangement of the mirror and the mirrored pinhole array forms a confocal mirrored pinhole array cavity.

5. The device of claim 1, where the mirrored pinhole array is at least one of: a round mirrored pinhole array, or a rectangular mirrored pinhole array.

6. The device of claim 1, wherein the one or more pinholes of the mirrored pinhole array are a first pinhole array disposed on a first location on the mirrored pinhole array, the device further comprising:
at least a second pinhole array disposed on second position on the mirrored pinhole array.

7. The device of claim 1, further comprising an excitation beam generator, the excitation beam generator configured to provide one or more excitation beams for the one or more sample planes.

8. The device of claim 1, further comprising a transmission grating, the transmission grating being disposed on a transmission side of the mirrored pinhole array, the transmission grating configured to separate the spectra of the light communicated between the mirrored pinhole array and the detector.

9. The device of claim 1, further comprising a tube lens, the tube lens arranged with the mirrored pinhole array cavity such that the tube lens focuses the at least some light from the one or more sample planes into the mirrored pinhole array cavity.

10. The device of claim 1, wherein the imaging device is a microscope, a spectroscope, or an imaging scanner.

11. The device of claim 1, wherein the mirrored pinhole array is configured such that a spacing of the one or more pinholes is at least one of: linear, or non-linear.

12. The device of claim 1, wherein the mirrored pinhole array is configured such that a spacing between the one or more pinholes is a function of a product of a square of the device magnification before the pinholes and a spacing between the one or more sampling planes.

13. The device of claim 1, wherein the mirrored pinhole array cavity is arranged such the at least some of the collected light corresponds to a passive axial sampling of the sample.

14. The device of claim 1, wherein the one or more properties of the sample comprise at least one of: a reflectance, a Raman effect, a fluorescence, or a stochastic radiation, at least one of the one or more properties of the sample being used for a super-resolution of the one or more sample planes.

15. A method of simultaneously measuring of one or more properties of a sample at one or more sample depths with an imaging device, the imaging device comprising a mirror, a mirrored pinhole array comprising one or more pinholes, at least one lens, and a detector, the method comprising:
arranging the mirror and the mirrored pinhole array to form a mirrored pinhole array cavity;
focusing at least some light from one or more sample planes within the mirrored pinhole array cavity;
arranging the mirrored pinhole array to collect at least some of the focused light from the one or more sample planes via at least one pinhole of the one or more pinholes; and
receiving, at the detector via the at least one lens, at least some of the collected light.

16. The method of claim 15, further comprising configuring the mirrored pinhole array such that the at least one pinhole of the one or more pinholes via which the at least some of the focused light from the one or more sample planes is communicated to the at least one lens based on at least one of: a sample plane from which the light originated, or a magnification of the device.

17. The method of claim 15, wherein the arranging of the mirror and the mirrored pinhole array includes forming a confocal mirrored pinhole array cavity.

18. The method of claim 15, wherein the one or more pinholes of the mirrored pinhole array are a first pinhole array disposed on a first location on the mirrored pinhole array, the method further comprising:
disposing at least a second pinhole array on second position on the mirrored pinhole array.

19. The method of claim 15, further comprising:
configuring the mirrored pinhole array such that a spacing between the one or more pinholes is based on a function of a product of a square of the device magnification before the pinholes and a spacing between the one or more sampling planes.

20. The method of claim 15, further comprising:
arranging a tube lens with the mirrored pinhole array cavity such that the tube lens focuses the at least some light from the one or more sample planes into the mirrored pinhole array cavity.
